(19) United States
(12) Patent Application Publication
(10) Pub. No.: US 2023/0096110 A1
(43) Pub. Date: Mar. 30, 2023

(54) SYSTEMS AND METHODS FOR PROVIDING OPEN ARC ENERGY NORMALIZATION

(71) Applicant: Rockwell Automation Technologies, Inc., MAYFIELD HEIGHTS, OH (US)

(72) Inventors: Kyle B. Adkins, Oak Creek, WI (US); Andrew E. Carlson, Oak Creek, WI (US); David Elmiger, Hitzkirch (CH)

(21) Appl. No.: 17/449,271

(22) Filed: Sep. 29, 2021

(51) Int. Cl. H01H 33/59

(52) U.S. Cl. CPC H01H 33/593; H01H 33/022

(57) ABSTRACT

A method may include receiving a command to move one or more armatures configured to move between a first position that electrically couples one or more first movable contacts to one or more second contacts and a second position that electrically uncouples the one or more first movable contacts from the one or more second contacts. The method may also include determining an operating frequency of the system, dynamically determining an open-before-zero target point associated with the operating frequency, and transmitting a command to the switching device to move the one or more armatures from the first position to the second position at the open-before-zero target point to normalize the arc energy over the operating frequency range.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a set of switching devices to provide power to an electrical load, in accordance with an embodiment;

FIG. 2 is a similar diagrammatical representation of a set of switching devices to provide power to an electrical motor, in accordance with an embodiment;

FIG. 3 is a system view of an example single-pole, single current-carrying path relay device, in accordance with an embodiment;

FIG. 4 shows an energy-frequency graph associated with an arc energy simulation analysis under a constant alpha open-before-zero target time according to an illustrative embodiment;

FIG. 5 shows an energy-frequency graph associated with an arc energy simulation analysis under a constant alpha open-before-zero target phase angle according to an illustrative embodiment;

FIG. 6 shows a normalized Alpha open-before-zero target-frequency curve associated with time according to an illustrative embodiment;

FIG. 7 shows a normalized Alpha open-before-zero target-frequency curve associated with phase angle according to an illustrative embodiment;

FIG. 8 shows an energy-frequency graph under normalized Alpha open-before-zero target and operating current in comparison with energy-frequency graphs in FIG. 4 and FIG. 5; and

FIG. 9 is a flowchart of a process for providing Alpha arc energy normalization to a switching device.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, switching devices are used in various implementations, such as industrial, commercial, material handling, manufacturing, power conversion, and/or power distribution systems, to connect and/or disconnect electric power from a load, such as an electric motor. As the switching devices open or close, electric power may be discharged as an electric arc and/or cause current oscillations to be supplied to the load, which may result in torque oscillations. To facilitate reducing the duration and/or magnitude of such effects, POW switching may be utilized to open and/or close the switching devices at specific points on an electric power waveform. However, opening a first set of contact(s) (e.g., Alpha contact) at a particular time or phase angle before the zero cross leads to a frequency-dependent contact opening energy, which could lead to inconsistent contact life between applications with different operating frequencies (e.g., different geographic locations with 50 Hz or 60 Hz grid frequency.)

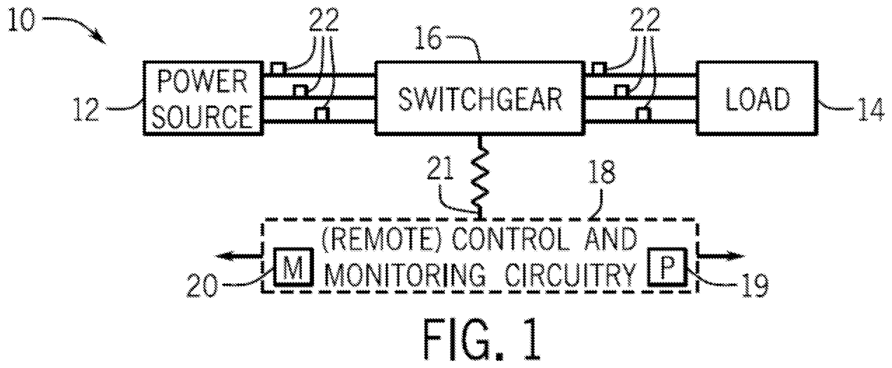

Accordingly, embodiments of the present disclosure provide systems and methods for dynamically calculating the Alpha open-before-zero target as a function of operating frequency to normalize the Alpha contact opening energy over frequency. In this way, a consistent contact life between applications with different operating frequencies can be achieved. Additional details related to providing open arc energy normalization will be discussed below with reference to FIGS. 1-11.

By way of introduction, FIG. 1 depicts a system 10 that includes a power source 12, a load 14, and switchgear 16, which includes one or more switching devices that may be controlled using the techniques described herein. In the depicted embodiments, the switchgear 16 may selectively connect and/or disconnect three-phase electric power output by the power source 12 to the load 14, which may be an electric motor or any other powered device. In this manner, electrical power flows from the power source 12 to the load 14. For example, switching devices in the switchgear 16 may close to connect electric power to the load 14. On the other hand, the switching devices in the switchgear 16 may open to disconnect electric power from the load 14. In some embodiments, the power source 12 may be an electrical grid.

It should be noted that the three-phase implementation described herein is not intended to be limiting. More specifically, certain aspects of the disclosed techniques may be employed on single-phase circuitry and/or for applications other than powering an electric motor. Additionally, it should be noted that in some embodiments, energy may flow from the power source 12 to the load 14. In other embodiments, energy may flow from the load 14 to the power source 12 (e.g., a wind turbine or another generator). More specifically, in some embodiments, energy flow from the load 14 to the power source 12 may transiently occur, for example, when overloading a motor.

In some embodiments, operation of the switchgear 16 (e.g., opening or closing of switching devices) may be controlled by control and monitoring circuitry 18. More specifically, the control and monitoring circuitry 18 may instruct the switchgear 18 to connect or disconnect electric power. Accordingly, the control and monitoring circuitry 18 may include one or more processors 19 and memory 20. More specifically, as will be described in more detail below, the memory 20 may be a tangible, non-transitory, computer-readable medium that stores instructions, which when executed by the one or more processors 19, performs various processes described herein. It would be noted that “non-transitory” merely indicates that the media is tangible and not a signal. Many different algorithms and control strategies may be stored in the memory and implemented by the processor 19, and these will typically depend upon the nature of the load, the anticipated mechanical and electrical behavior of the load, the particular implementation, behavior of the switching devices, and so forth.

Additionally, as depicted, the control and monitoring circuitry 18 may be remote from the switchgear 16. In other words, the control and monitoring circuity 18 may be communicatively coupled to the switchgear 16 via a network 21. In some embodiments, the network 21 may utilize various communication protocols such as DeviceNet, Profibus, Modbus, and Ethernet, to mention only a few. For example, to transmit signals, the control and monitoring circuitry 18 may utilize the network 21 to send close and/or open instructions to the switchgear 16. The network 21 may also communicatively couple the control and monitoring circuitry 18 to other parts of the system 10, such as other control circuitry or a human-machine-interface (not separately depicted). Additionally, the control and monitoring circuitry 18 may be included in the switchgear 16 or directly coupled to the switchgear 16, for example, via a serial cable.

Furthermore, as depicted, the electric power input to the switchgear 16 and output from the switchgear 16 may be monitored by sensors 22. More specifically, the sensors 22 may monitor (e.g., measure) the characteristics (e.g., voltage or current) of the electric power. Accordingly, the sensors 22 may include voltage sensors and current sensors. These sensors may alternatively be modeled or calculated values determined based on other measurements (e.g., virtual sensors). Many other sensors and input devices may be used, depending upon the parameters available and the application. Additionally, the characteristics of the electric power measured by the sensors 22 may be communicated to the control and monitoring circuitry 18 and used as the basis for algorithmic computation and generation of waveforms (e.g., voltage waveforms or current waveforms) that depict the electric power. More specifically, the waveforms that are generated based on input from the sensors 22 monitoring the electric power input into the switchgear 16 may be used to define the control of the switching devices, for example, by reducing electrical arcing when the switching devices open or close. The waveforms that are generated based on input from the sensors 22 monitoring the electric power output from the switchgear 16 and supplied to the load 14 may be used in a feedback loop to, for example, monitor conditions of the load 14.

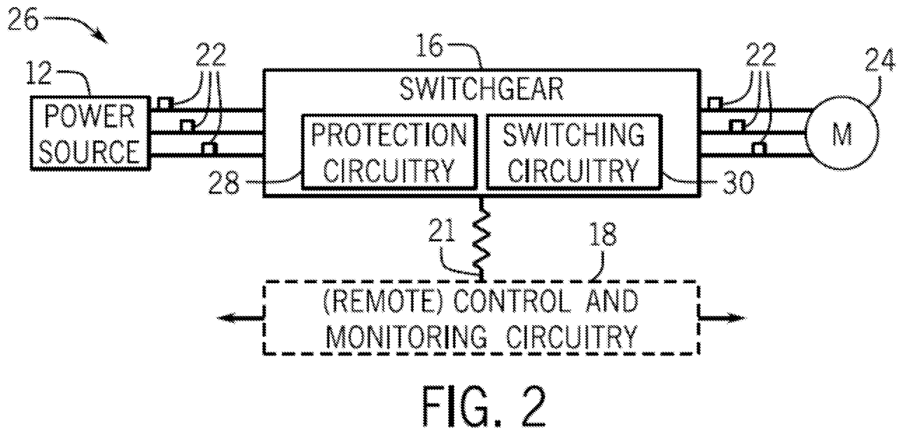

As described above, the switchgear 16 may connect and/or disconnect electric power from various types of loads 14, such as an electric motor 24 included in the motor system 26 depicted in FIG. 2. As depicted, the switchgear 16 may connect and/or disconnect the power source 12 from the electric motor 24, such as during startup and shutdown. Additionally, as depicted, the switchgear 16 will typically include or function with protection circuitry 28 and the actual switching circuitry 30 that makes and breaks connections between the power source and the motor windings. More specifically, the protection circuitry 28 may include fuses and/or circuit breakers, and the switching circuitry 30 will typically include relays, contacts, and/or solid-state switches (e.g., silicon controlled rectifiers (SCRs), metal-oxide-semiconductor field-effect transistors (MOSFETs), insulated-gate bipolar transistors (IGBTs), and/or gate turn-off thyristor (GTOs)), such as within specific types of assembled equipment (e.g., motor starters).

More specifically, the switching devices included in the protection circuitry 28 may disconnect the power source 12 from the electric motor 24 when an overload, a short circuit condition, or any other unwanted condition is detected. Such control may be based on the un-instructed operation of the device (e.g., due to heating, detection of excessive current, and/or internal fault), or the control and monitoring circuitry 18 may instruct the switching devices (e.g., contacts or relays) included in the switching circuitry 30 to open or close. For example, the switching circuitry 30 may include one (e.g., a three-phase contact) or more contacts (e.g., three or more single-pole, single current-carrying path switching devices).

Accordingly, to start the electric motor 24, the control and monitoring circuitry 18 may instruct the one or more contacts in the switching circuitry 30 to close individually, together, or in a sequential manner. On the other hand, to stop the electric motor 24, the control and monitoring circuitry 18 may instruct the one or more contacts in the switching circuitry 30 to open individually, together, or in a sequential manner. When the one or more contacts are closed, electric power from the power source 12 is connected to the electric motor 24 or adjusted and, when the one or more contacts are open, the electric power is removed from the electric motor 24 or adjusted. Other circuits in the system may provide controlled waveforms that regulate operation of the motor (e.g., motor drives, automation controllers, etc.), such as based upon movement of articles or manufacture, pressures, temperatures, and so forth. Such control may be based on varying the frequency of power waveforms to produce a controlled speed of the motor.

In some embodiments, the control and monitoring circuitry 18 may determine when to open or close the one or more contacts based at least in part on the characteristics of the electric power (e.g., voltage, current, or frequency) measured by the sensors 22. Additionally, the control and monitoring circuitry 18 may receive an instruction to open or close the one or more contacts in the switching circuitry 30 from another part of the motor system 26, for example, via the network 21.

The control and monitoring circuitry 18 may include a programmable logic controller (PLC) that locally (or remotely) controls operation of the switchgear 16. For example, the control and monitoring circuitry 18 may instruct the switchgear 16 to connect or disconnect electric power. Accordingly, the control and monitoring circuitry 18 may include a tangible non-transitory computer-readable medium on which instructions are stored. As will be described in more detail below, the computer-readable instructions may be configured to perform various processes described when executed by one or more processors. In some embodiments, the control and monitoring circuitry 18 may also be included within the switchgear 16.

Moreover, sensors 22 may be included throughout the machine or process system 34. More specifically, as depicted, sensors 22 may monitor electric power supplied to the switchgear 16, electric power supplied to the motor controller/drive 32, and electric power supplied to the electric motor 24. For example, in a manufacturing process, sensors 22 may be included to measure speeds, torques, flow rates, pressures, the presence of items and components, or any other relevant parameters. As described above, the sensors 22 may feedback information gathered regarding the switchgear 16 and/or the motor 24 to the control and monitoring circuitry 18 in a feedback loop. Additionally, the sensors 22 may provide the gathered information directly to the remote control and monitoring circuitry 18, for example, via the network 21.

The electric motor 24 may convert electric power to provide mechanical power. To help illustrate, an electric motor 24 may provide mechanical power to various devices. For example, the electric motor 24 may provide mechanical power to a fan, a conveyer belt, a pump, a chiller system, and various other types of loads that may benefit from the advances proposed.

As discussed in the above examples, the switchgear 16 may control operation of a load (e.g., electric motor 24) by controlling electric power supplied to the load 14. For example, switching devices (e.g., contacts) in the switchgear 16 may be closed to supply electric power to the load 14 an opened to disconnect electric power from the load 14.

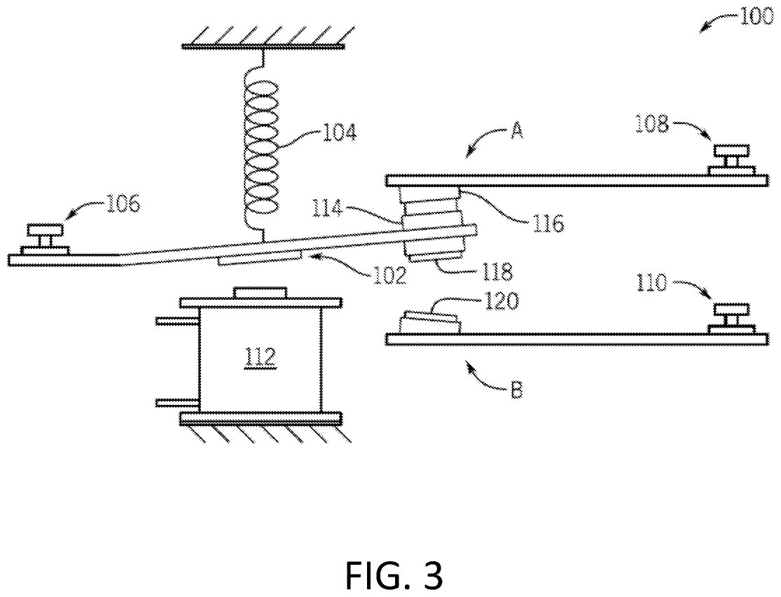

By way of example, the switching device may include a relay device 100 that is composed of components illustrated in FIG. 3, some of which correspond to the components of the switching device described above. As shown in FIG. 3, the relay device 100 may include an armature 102 that is coupled to a spring 104. The armature 102 may have a common contact 106 that may be coupled to a part of an electrical circuit. The armature 102 may electrically couple the common contact 106 to a contact 108 or to a contact 110 depending on a state (e.g., energized) of the relay device 100. For example, when a relay coil 112 of the relay device 100 is not energized or does not receive voltage form a driving circuit, the armature 102 is positioned such that the common contact 106 and the contact 108 are electrically coupled to each other. When the relay coil 112 receives a driving current, the relay coil 112 magnetizes and attracts the armature 102 to itself, thereby connecting the contract 110 to the common contact 106.

The electrical connections between the common contact 106 and the contacts 108 and 110 are made via contacts 114 and 116 and contacts 118 and 120, respectively. Over time, as the contacts 114 and 116 and the contacts 118 and 120 strike against each other, the conductive material of the contacts 114, 116, 118, and 120 may begin to wear.

Moreover, the relay coil 112 may include a core that minimizes a core flux during the operation of the relay device 100. That is, as the armature 102 moves between connecting to the contact 108 and the contact 110, and vice-versa, a magnetic flux may be generated in a core of the relay coil 112 and/or the armature 102. This magnetic flux may be related to the core flux of the relay coil 112 and may change over time as the relay device operates.

As discussed in the above examples, the switchgear 16 may control operation of a load 14 (e.g., electric motor 24) by controlling electric power supplied to the load 14. For example, switching devices (e.g., contacts) in the switchgear 16 may be closed to supply electric power to the load 14 and opened to disconnect electric power form the load 14. However, as discussed above, opening (e.g., breaking) and closing (e.g., making) the switching devices may discharge electric power in the form of electric arcing, thereby causing current oscillations to be supplied to the load 14, and/or cause the load 14 to produce torque oscillations. Opening the contacts at specific points on the electric current waveform can minimize opening arc energy, which leads to minimal contact material erosion and increased contact life. However, opening a first set of contacts at a particular time or phase angle before the zero cross leads to a frequency-dependent contact opening energy, which leads to inconsistent contact life between applications with different operating frequencies.

Accordingly, embodiments of the present disclosure provide systems and methods for dynamically calculating an Alpha open-before-zero target as a function of operating frequency to normalize the Alpha contact opening energy over frequency. When the contacts open at the calculated Alpha open-before-zero target, the contacts may achieve a consistent operating life between applications with different operating frequencies.

Although certain embodiments describe opening a switching device based on a calculated Alpha open-before-zero target, it should be understood that the switching devices may be controlled to open and close at any desired point on the waveform using the disclosed techniques. To facilitate opening and/or closing at a desired point on the waveform, one or more switching devices may be independently controlled to selectively connect and disconnect a phase of electric power to the load 14. In some embodiments, the one or more switching devices may be a multi-pole, multi-current carrying path switching device that controls connection of each phase with a separate pole. More specifically, the multi-pole, multi-current carrying path switching device may control each phase of electric power by movement of a common assembly under the influence of a single operation (e.g., an electromagnetic operator). Thus, in some embodiments, to facilitate independent control, each pole may be connected to the common assembly in an offset manner, thereby enabling movement of the common assembly to affect one or more of the poles differently.

In other embodiments, the one or more switching devices may include multiple single pole switching devices. As used herein, a “single pole switching device” is intended to differentiate from a multi-pole, multi-current-carrying path switching device in that each phase is controlled by movement of a separate assembly under influence of a separate operator. In some embodiments, the single pole switching device may be a single pole, multi-current carrying path switching device (e.g., multiple current carrying paths controlled by movement of a single operator) or a single-pole, single current-carrying path switching device, as described herein.

As described above, controlling the opening of the one or more switching devices may facilitate the reduction or arc energy and contact erosion. As such, the one or more switching devices may be controlled such that the switching devices open based at least in part on a calculated Alpha open-before-zero target as a function of operating frequency to normalize the Alpha contact opening energy over frequency.

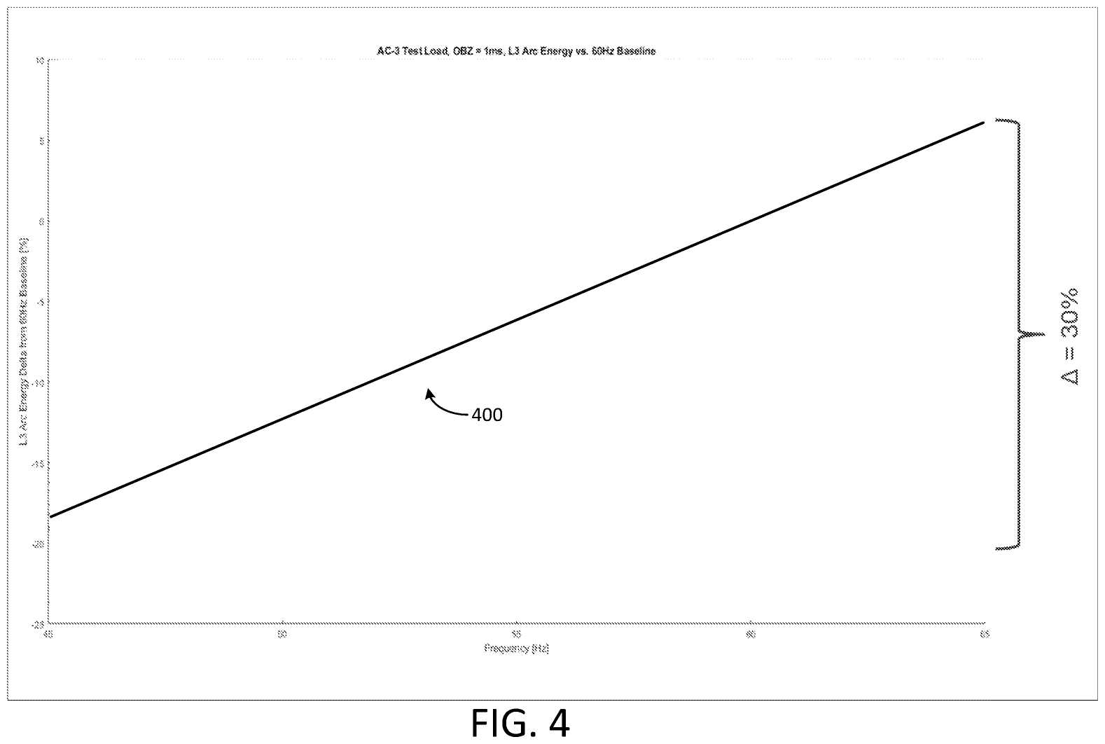

With the foregoing in mind, FIG. 4 illustrates an energy-frequency graph 400 associated with an arc energy simulation analysis under a constant alpha open-before-zero target time. The example switching device may open a first set of one or more contacts at a constant alpha open-before-zero target time of 1 millisecond. When the first set of one or more contacts are open under each breaking current, Alpha arc energy is measured over a range of frequencies (e.g., frequencies from 45 Hz to 65 Hz.) As shown in the energy-frequency graph 400, the Alpha arc energy-frequency curve is generated and normalized over a baseline at 60 Hz to illustrate the overall trend of the arc energy curve. Under the constant alpha open-before-zero target time, the Alpha arc energy increases along the frequency. For example, a deviation from the arc energy at the frequency 65 Hz to the arc energy at frequency 45 Hz reaches 30%. This analysis proves that the Alpha arc energy is frequency-dependent under the constant alpha open-before-zero target time, which can lead to inconsistent contact life between applications with different operating frequencies.

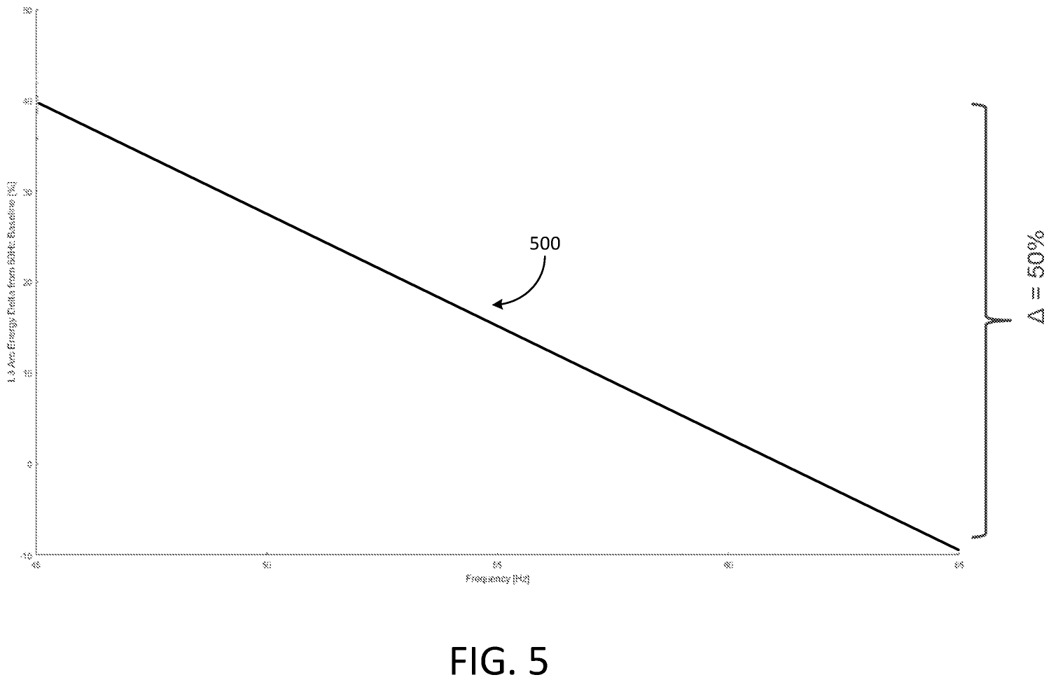

FIG. 5 illustrates an energy-frequency graph 500 associated with an arc energy simulation analysis under a constant alpha open-before-zero target phase angle. The example switching device may open a first set of one or more contacts at a constant alpha open-before-zero target phase angle of 21.6 degrees. When the first set of one or more contacts are open under each breaking current, Alpha arc energy is measured over a range of frequencies (e.g., frequencies from 45 Hz to 65 Hz.) As shown in the energy-frequency graph 500, the Alpha arc energy-frequency curve is generated and normalized over a baseline at 60 Hz to illustrate the overall trend of the arc energy curve. Under the constant alpha open-before-zero target phase angle, the Alpha arc energy decreases along the frequency. For example, a deviation from the arc energy at the frequency 65 Hz to the arc energy at frequency 45 Hz reaches 50%. This analysis proves that the Alpha arc energy is frequency-dependent under a constant Alpha open-before-zero target phase angle, which can lead to inconsistent contact life between applications with different operating frequencies.

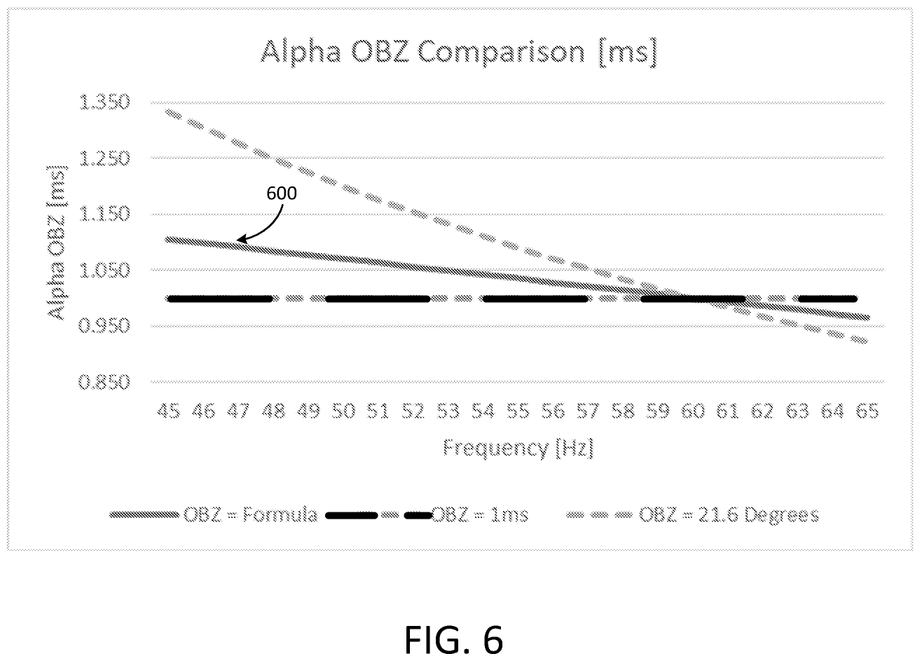

In order to eliminate the frequency dependency of the Alpha arc energy, systems and methods for providing a normalized Alpha arc energy over frequency are provided. Instead of using a constant Alpha open-before-zero target time, an Alpha open-before-zero target time can be dynamically calculated using the following formula and/or the Alpha open-before-zero target-frequency curve 600 as shown in FIG. 6 to normalize the arc energy over frequency:

$$Alpha OBZ [ ms ] = ( - \frac{Frequency}{143} ) + 1.42$$

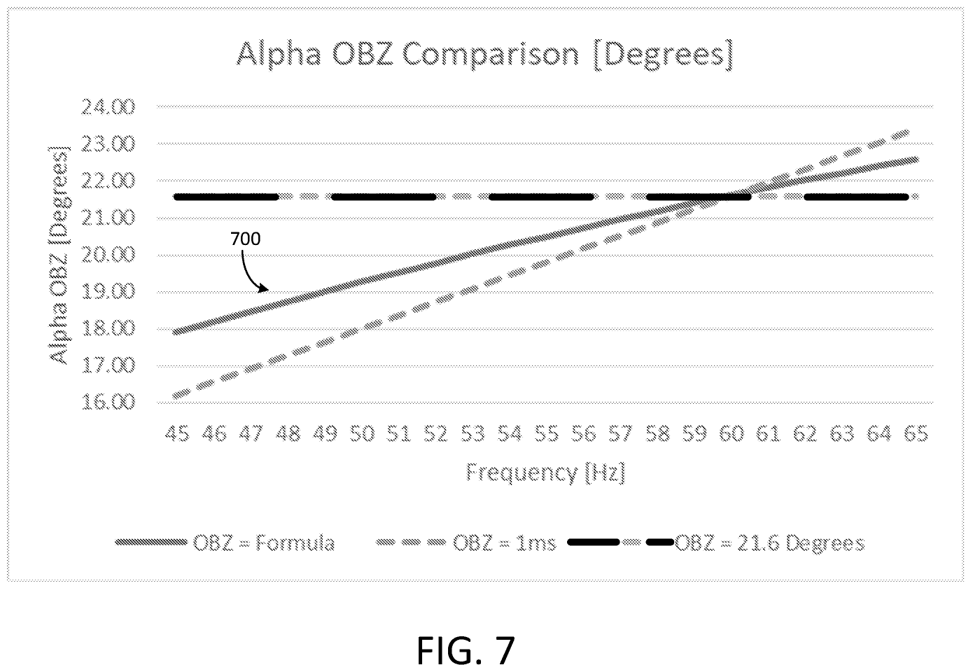

Similarly, instead of using a constant Alpha open-before-zero target phase angle, an Alpha open-before-zero target phase angle can be dynamically calculated using the following formula and/or the normalized Alpha open-before-zero target-frequency curve 700 as shown in FIG. 7 to normalize the arc energy over frequency:

$$Alpha OBZ [ Degrees ] = ( \frac{Frequency}{4.27} ) + 7.56$$

These normalized formulas and curves can be applied to any switching devices by adapting normalization factors to specific devices. These normalization factors can be generated by one or more experiments conducted on the specific device.

In some embodiments, an Alpha open-before-zero target time can be determined according to an Alpha open-before-zero target time lookup table. The target time lookup table includes a plurality of pairs of frequency and target time data. Each pair of frequency and target time data includes an operating frequency, and a corresponding Alpha open-before-zero target time for the operating frequency. A switching device operates according to this target time lookup table will result similar Alpha arc energy level over the plurality of frequencies. In this way, the Alpha arc energy does not depend on an operating frequency of an industrial system where in the switching device is installed. In some embodiments, each pair of frequency and target time data is determined according one or more experiments conducted on the switching device.

Similarly, an Alpha open-before-zero target phase angle can be determined according to an Alpha open-before-zero target phase angle lookup table. The target phase angle lookup table includes a plurality of pairs of frequency and target phase angle data. Each pair of frequency and target time data includes an operating frequency, and a corresponding Alpha open-before-zero target phase angle for the operating frequency. A switching device operates according to this target phase angle lookup table will result similar Alpha arc energy level over the plurality of frequencies. In this way, the Alpha arc energy does not depend on an operating frequency of an industrial system where in the switching device is installed. In some embodiments, each pair of frequency and target phase angle data is determined according one or more experiments conducted on the switching device.

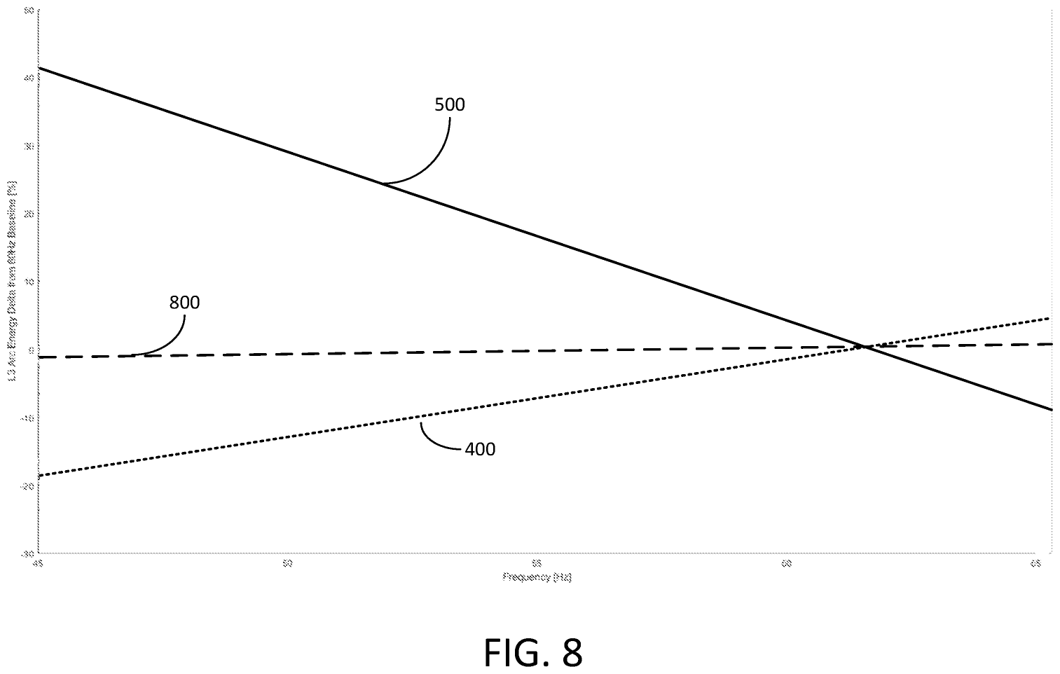

With the foregoing in mind, FIG. 8 illustrates energy-frequency graph 800 in comparison with energy-frequency graphs 400 of FIGS. 4 and 500 of FIG. 5. The energy-frequency graph 800 is associated with an arc energy simulation analysis under a normalized Alpha open-before-zero calculated using the foregoing formulas. The example switching device may open a first set of one or more contacts at a calculated normalized Alpha open-before-zero associated with a corresponding frequency. When the first set of one or more contacts are opened, Alpha arc energy is measured over a range of frequencies (e.g., frequencies from 45 Hz to 65 Hz.) As shown in the energy-frequency graph 800, the Alpha arc energy-frequency curve is generated and normalized over a baseline at 60 Hz to illustrate the overall trend of the arc energy curve. Under the normalized Alpha open-before-zero, the Alpha arc energy only has small changes along frequency. For example, a deviation from the arc energy at the frequency 65 Hz to the arc energy at frequency 45 Hz can be reduced to 3%. This comparison proves that the normalized Alpha arc energy does not depend on the frequency under the normalized Alpha open-before-zero, which can lead to consistent contact life between applications with different operating frequencies.

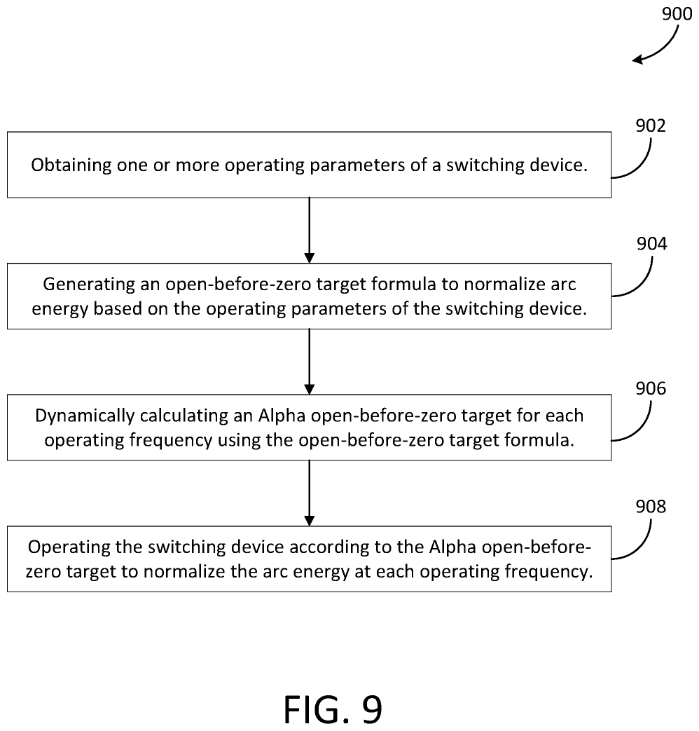

FIG. 9 is a flowchart of a process 900 for providing Alpha arc energy normalization to a switching device. For example, the Alpha open-before-zero associated with the normalized arc energy may be employed to open the switching device (e.g., one or more contacts of the switching device) to minimize the magnitude and/or duration of arcing when opening the switching device and/or to normalize the arc energy over operating frequency. It should be noted that although the process 900 will be described as being performed by the control and monitoring circuitry 18, it should be understood that the process 900 may be performed by any suitable control system or computing device. In addition, although the process 900 is described in a particular order, it should be noted that the process 900 may be performed in any suitable order.

At operation 902, the control and monitoring circuitry 18 may obtain one or more operating parameters of a switching device. For example, the one or more operating parameters may include a frequency range at which the switch device is configured to operate. The one or more operating parameters may include rated operating voltage, rated frequency, rated operating current, internal relay/contactor contact gap, relay/contactor armature opening speed, etc.

At operation 904, the control and monitoring circuitry 18 may generate an open-before-zero target formula to normalize the arc energy based on the operating parameters of the switching device. The open-before-zero target formula to normalize the arc energy is a function of operating frequency of the switching device. The open-before-zero target formula can be associated with open-before-zero target time or open-before-zero phase angle. In some embodiments, the open-before-zero target formula includes one or more normalization factors. The one or more normalization factors are associated with the operating parameters of the switching device. In some embodiments, the open-before-zero target formula is generated using an Alpha arc energy-frequency curve under a constant open-before-zero target time and an Alpha arc energy-frequency curve under a constant open-before-zero target phase angle. The open-before-zero target formula is generated so that, at each operating frequency of the switching device, a corresponding arc energy under the open-before-zero target is within a desired energy range (e.g., within a 3% deviation range).

At operation 906, the control and monitoring circuitry 18 may dynamically calculate an Alpha open-before-zero target for each operating frequency using the open-before-zero target formula to normalize the arc energy. In this way, the switching device may achieve a consistent contact life under different operating frequencies.

At operation 908, the control and monitoring circuitry 18 may operate the switching device according to the Alpha open-before-zero target to normalize the arc energy at each operating frequency.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

While only certain features of the embodiments detailed above have been illustrated and described herein, many modifications and changes will occur to those skilled in the art. It is, therefore, to be understood that the appended claims are intended to cover all such modifications and changes as fall within the true spirit of the embodiments described herein.

### BACKGROUND

The present disclosure relates generally to switching devices. More specifically, the present disclosure is related to improved operation and configuration of the switching devices.

Switching devices are generally used throughout industrial, commercial, material handling, process and manufacturing settings, to mention only a few. As used herein, a “switching device” is generally intended to describe any electromechanical switching device, such as mechanical switching devices (e.g., a contact, a relay, air break devices, and controlled atmosphere devices) or solid-state devices (e.g., a silicon-controlled rectifier (SCR)). More specifically, switching devices generally open to disconnect electric power from a load and close to connect electric power to the load. For example, switching devices may connect and disconnect three-phase electric power to an electric motor. As the switching devices open or close, electric power may be discharged as an electric arc and/or cause current oscillations to be supplied to the load, which may result in torque oscillations. To facilitate reducing the duration and/or magnitude of such effects, the switching devices may be opened and/or closed at specific points on the electric power waveform. Such carefully timed switching is sometimes referred to as “point on wave” or “POW” switching. However, depending on the electric motor, a power factor associated with the electric motor may change based on the load current. For example, the power factor may range from five percent to ninety percent based on the load current. As the power factor of the electric motor changes, the timing of the POW switching along the electric power waveform may deviate until a steady state of the load current is reached. Accordingly, it may be beneficial to employ improved systems and methods for POW switching to facilitate opening or closing of the switching device at a specific point on the electric power waveform.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a system may include a switching device that has one or more armatures configured to move between a first position that electrically couples one or more first movable contacts to one or more second contacts and a second position that electrically uncouples the one or more first movable contacts from the one or more second contacts. The switching device may also have a relay coil that may receive a current that magnetizes the relay coil, thereby causing the armature to move from the first position to the second position. The system may also include a control system that may perform operations that include receiving a command to move the one or more armatures from the first position to the second position, determining an operating frequency of the system, dynamically determining a normalized open-before-zero target point associated with the operating frequency, and transmitting a command to the switching device to move the one or more armatures from the first position to the second position at the normalized open-before-zero target point.

In another embodiment, a non-transitory, computer-readable storage medium may include instructions that, when executed by one or more processors, cause the processors to perform operations that include receiving a command to move one or more armatures of a switching device from a first position that electrically couples one or more first movable contacts to one or more second contacts and a second position that electrically uncouples the one or more first movable contacts from the one or more second contacts. The operations may also include determining an operating frequency of an industrial system where the switching device is installed, dynamically determining a normalized open-before-zero target point associated with the operating frequency, and transmitting a command to the switching device to move the one or more armatures from the first position to the second position at the normalized open-before-zero target point.

In yet another embodiment, a method may include receiving a command to move one or more armatures of a switching device from a first position that electrically one or more first movable contacts to one or more second contacts and a second position that electrically uncouples the one or more first movable contacts from the one or more second contacts. The method may also include determining an operating frequency of an industrial system where the switching device is installed, dynamically determining a normalized open-before-zero target point associated with the operating frequency, and transmitting a command to the switching device to move the one or more armatures from the first position to the second position at the normalized open-before-zero target point.

1. A system, comprising:
a switching device, comprising:
one or more armatures configured to move between a first position that electrically couples one or more first movable contacts to one or more second contacts and a second position that electrically uncouples the one or more first movable contacts from the one or more second contacts; and
a relay coil configured to receive a current configured to magnetize the relay coil, thereby causing the one or more armatures to move from the first position to the second position; and
a control system configured to perform operations comprising:
receiving a command to move the one or more armatures from the first position to the second position;
determining an operating frequency of the system;
dynamically determining an open-before-zero target point associated with the operating frequency; and
transmitting a command to the switching device to move the one or more armatures from the first position to the second position at the open-before-zero target point.

2. The system of claim 1, wherein the control system is configured to perform the operations comprising generating an open-before-zero target formula to normalize the opening arc energy over operating frequency, wherein the open-before-zero target formula is a function of frequency.

3. The system of claim 2, wherein the open-before-zero target point is determined by calculating an open-before-zero target time or calculating an open-before-zero target phase angle using the open-before-zero target formula.

4. The system of claim 3, wherein the open-before-zero target point is determined based on the operating frequency of the system according to the open-before-zero target formula.

5. The system of claim 1, wherein the open-before-zero target formula is generated using an arc energy-frequency curve under constant open-before-zero target time and an arc energy-frequency curve under constant open-before-zero target phase angle.

6. The system of claim 2, wherein the open-before-zero target formula is generated so that, at each operating frequency of the switching device, a corresponding arc energy under the open-before-zero target is within an energy range.

7. The system of claim 6, wherein the open-before-zero target formula is generated according to one or more operating parameters of the switching device.

8. The system of claim 1, wherein dynamically determining an open-before-zero target point associated with the operating frequency comprises using a lookup table to determine the open-before-zero target point associated with the operation frequency.

9. A non-transitory, computer-readable storage medium, comprising instructions that, when executed by one or more processors, cause the one or more processors to perform operations comprising:
receiving a command to move one or more armatures of a switching device from a first position to a second position, wherein the first position of the one or more armatures electrically couples one or more first movable contacts to one or more second contacts and the second position of the one or more armatures electrically uncouples the first one or more movable contacts from the one or more second contacts;
determining an operating frequency of an industrial system where the switching device is installed;
dynamically determining an open-before-zero target point associated with the operating frequency; and
transmitting a command to the switching device to move the one or more armatures from the first position to the second position at the open-before-zero target point.

10. The non-transitory, computer-readable storage medium of claim 9, wherein the operations comprise generating an open-before-zero target formula to normalize the opening arc energy over operating frequency, wherein the open-before-zero target formula is a function of frequency.

11. The non-transitory, computer-readable storage medium of claim 10, wherein the open-before-zero target point is determined by calculating an open-before-zero target time or calculating an open-before-zero target phase angle using the open-before-zero target formula.

12. The non-transitory, computer-readable storage medium of claim 11, wherein the open-before-zero target point is determined based on the operating frequency of the industrial system according to the open-before-zero target formula.

13. The non-transitory, computer-readable storage medium of claim 10, wherein the operations comprise wherein the open-before-zero target formula is generated using an arc energy-frequency curve under constant open-before-zero target time and an arc energy-frequency curve under constant open-before-zero target phase angle.

14. The non-transitory, computer-readable storage medium of claim 9, wherein the open-before-zero target formula is generated so that, at each operating frequency of the switching device, a corresponding arc energy under the open-before-zero target is within an energy range.

15. The non-transitory, computer-readable storage medium of claim 9, wherein dynamically determining an open-before-zero target point associated with the operating frequency comprises using a lookup table to determine the open-before-zero target point associated with the operation frequency.

16. A method, comprising:
receiving, via one or more processors, a command to move one or more armatures of a switching device from a first position to a second position, wherein the first position of the one or more armatures electrically couples one or more first contacts to one or more second contacts and the second position of the one or more armatures electrically uncouples the one or more first contacts from the one or more second contacts;
determining, via the one or more processors, an operating frequency of an industrial system where the switching device is installed;
determining, via the one or more processors, determining an open-before-zero target point associated with the operating frequency; and
transmitting, via the one or more processors, a command to the switching device to move the one or more armatures from the first position to the second position at the open-before-zero target point.

17. The method of claim 16, further comprising generating an open-before-zero target formula to normalize the opening arc energy over operating frequency, wherein the open-before-zero target formula is a function of frequency.

18. The method of claim 17, wherein the open-before-zero target point is determined by calculating an open-before-zero target time or calculating an open-before-zero target phase angle using the open-before-zero target formula.

19. The method of claim 18, wherein the open-before-zero target point is determined based on the operating frequency of the industrial system according to the open-before-zero target formula.

20. The method of claim 16, wherein dynamically determining an open-before-zero target point associated with the operating frequency comprises using a lookup table to determine the open-before-zero target point associated with the operation frequency.
